(19) United States
(12) Patent Application Publication
(10) Pub. No.: US 2019/0089134 A1
(43) Pub. Date: Mar. 21, 2019

(54) SURGE PROTECTIVE DEVICE

(71) Applicant: MITSUBISHI MATERIALS CORPORATION, Tokyo (JP)

(72) Inventors: Yoshitaka Mayuzumi, Naka-shi (JP); Ryoichi Sugimoto, Naka-shi (JP); Shinji Sakai, Naka-shi (JP)

(21) Appl. No.: 16/086,448

(22) PCT Filed: Mar. 17, 2017
(86) PCT No.: PCT/JP2017/010976

§ 371 Date: Sep. 19, 2018

(30) Foreign Application Priority Data
Apr. 26, 2016 (JP) 2016-087678

(51) Int. Cl. H01T 4/12; H01T 2/02; H01T 1/22

(52) U.S. Cl. CPC H01T 4/12; H01T 1/22; H01T 2/02

(57) ABSTRACT

A surge protective device of the present invention includes an insulating tube, a pair of sealing electrodes for closing openings on both ends of the insulating tube so as to seal a discharge control gas inside the tube, wherein the pair of sealing electrodes has a pair of convex electrode portions projecting inwardly so as to face to each other, and at least one groove part extending in a circumferential direction is formed on the inner circumferential surface of the insulating tube.

### BACKGROUND OF THE INVENTION

### Field of the Invention

The present invention relates to a surge protective device for protecting a wide variety of equipment from surges caused by a lightning strike or the like so as to prevent accidents.

### Description of the Related Art

The connecting parts of telephones, facsimile machines, and electronic devices for communication equipment such as a modem to communication lines, and power lines, antenna, as well as image display driving circuits for CRTs, liquid crystal display TVs, plasma display TVs, and the like are vulnerable to electric shocks such as abnormal voltage (surge voltage) due to a lightning surge or electrostatic surge. To these parts are installed surge protective devices in order to prevent electronic devices and the printed circuit boards equipped therewith from being broken down due to thermal damage, ignition, or the like caused by abnormal voltage.

As conventional technologies, Patent documents 1 and 2, for example, disclose an arrester (surge protective device) which includes an insulating tube being a cylindrical body made of ceramic, glass, or the like, and a pair of convex electrode portions projecting from a pair of sealing electrodes for sealing the insulating tube so as to face to each other.

### PRIOR ART DOCUMENTS

### Patent Documents

[Patent Document 1] Japanese Utility Model Registration No. 3151069

[Patent Document 2] Japanese Unexamined Patent Application Publication H05-36460

### SUMMARY OF THE INVENTION

### Problems to be Solved by the Invention

The following problems still remain in the conventional technologies described above.

Specifically, a metal constituting the convex electrode portions can be melt and scattered by an arc discharge and then the metal component can adhere to the inner surface of the insulating tube, which may deteriorate the insulation between the pair of sealing electrodes. In particular, when a surge application current is greater than 10 kA, a metal can be scattered remarkably. In addition, when a large amount of metal component adheres to the inner surface of the insulating tube, an energization circuit may be formed on the inner circumferential surface of the insulating tube, thereby causing a short circuit. In such a case, this surge protective device may be mistakenly considered to end its operating life.

The present invention has been made in view of the aforementioned circumstances, and an object of the present invention is to provide a surge protective device that can suppress the occurrence of a short circuit due to the adhesion of a metal component scattered by an arc discharge.

### Means for Solving the Problems

The present invention adopts the following configuration in order to overcome the aforementioned problems. Specifically, a surge protective device according to a first aspect of the present invention, comprises: an insulating tube and a pair of sealing electrodes for closing openings on both ends of the insulating tube so as to seal a discharge control gas inside the tube; wherein the pair of sealing electrodes has a pair of convex electrode portions projecting inwardly so as to face to each other, and at least one groove part extending in a circumferential direction is formed on the inner circumferential surface of the insulating tube.

Specifically, in this surge protective device, since at least one groove part extending in a circumferential direction is formed on the inner circumferential surface of the insulating tube, even when a metal component scattered by an arc discharge adheres to the inner circumferential surface of the insulating tube, it is hard to enter the groove part. Hence, an energization circuit is hard to be formed due to the adhered metal, and thus the occurrence of a short circuit can be suppressed. In addition, the groove part can lengthen the creepage distance between the sealing electrodes through the inner circumferential surface of the insulating tube, and this can also preclude the formation of an energization circuit due to the adhered metal.

A surge protective device according to a second aspect of the present invention is characterized by the surge protective device according to the first aspect, wherein a plurality of the groove parts are formed in the axial direction of the insulating tube.

Specifically, in this surge protective device, since the plurality of groove parts are formed in the axial direction of the insulating tube, the formation of an energization circuit due to the adhered metal can be suppressed by the plurality of groove parts, which can further prevent the occurrence of a short circuit.

A surge protective device according to a third aspect of the present invention is characterized by the surge protective device according to the first or second aspect, wherein the groove part(s) is(are) formed at least in the vicinity of the opening(s) of the insulating tube.

Specifically, in this surge protective device, since the groove part(s) is(are) formed at least in the vicinity of the opening(s) of the insulating tube, the groove part(s) can be located in the vicinity of the opening(s) to which a metal component due to arc discharge is harder to adhere than to the central region. Therefore, the occurrence of a short circuit between the pair of sealing electrodes can be effectively prevented.

A surge protective device according to a fourth aspect of the present invention is characterized by the surge protective device according to any one of the first to third aspects, wherein the inner surface of the groove part(s) on the intermediate position side in the insulating tube is inclined from the inner circumferential surface of the insulating tube towards the intermediate position side.

Specifically, in this surge protective device, since the inner surface of the groove part(s) on the intermediate position side in the insulating tube is inclined from the inner circumferential surface of the insulating tube towards the intermediate position side, even when a metal component scattered from the tip side of the pair of convex electrode portions by an arc discharge tries to adhere to the inside of the groove part(s), it is hard to adhere to the inner surface because it is shaded by the surface of the groove part(s) on the intermediate position side in the direction that the metal component scatters. Therefore, an energization circuit can be further hard to be formed due to the adhered metal.

### Effects of the Invention

According to the present invention, the following effects may be provided.

Specifically, according to the surge protective device of the present invention, since at least one groove part extending in a circumferential direction is formed on the inner circumferential surface of the insulating tube, even when a metal component scattered by an arc discharge adheres to the inner circumferential surface of the insulating tube, it is hard to enter the groove part. Hence, an energization circuit is hard to be formed due to the adhered metal, and thus the occurrence of a short circuit can be suppressed.

Therefore, the surge protective device of the present invention can achieve a long operating life, and the number of surge application by which the device is capable of operating can be increased. In particular, the surge protective device of the present invention is suitable for the power source and communication equipment for infrastructure (railroad-related or regenerated energy-related (e.g., solar cell, wind power generation, and the like)) where the tolerance to a large current surge is required.

### BRIEF DESCRIPTION OF THE DRAWINGS

FIG. 1 is an axial cross-sectional view showing a surge protective device according to a first embodiment of the present invention.

FIG. 2 is a cross-sectional view along line A-A in FIG. 1.

FIG. 3 is an axial cross-sectional view showing a surge protective device according to a second embodiment of the present invention.

FIG. 4 is an enlarged cross-sectional view showing the essential part of the surge protective device according to the second embodiment.

### DESCRIPTION OF THE EMBODIMENTS

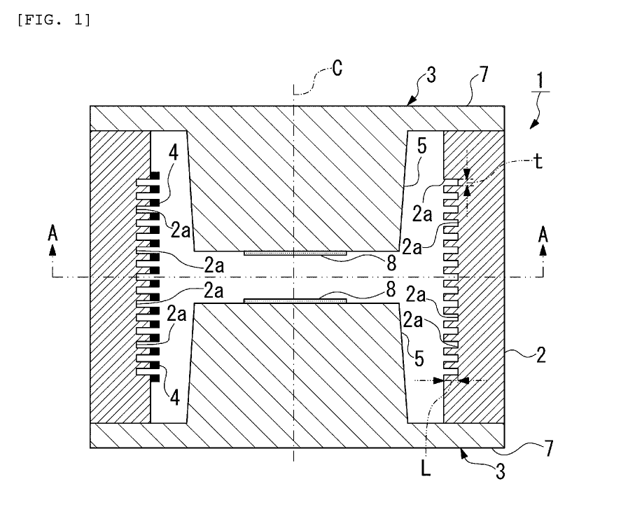

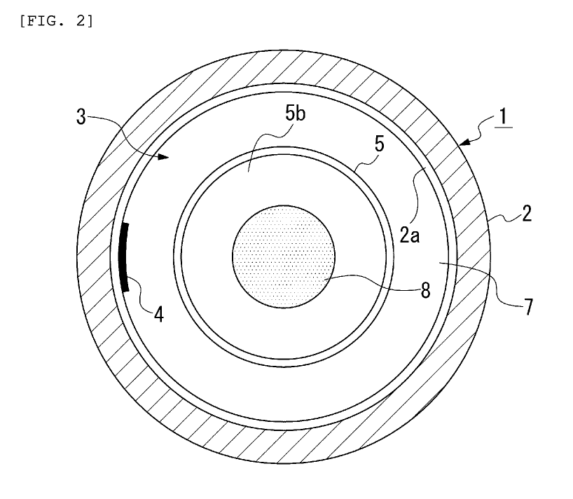

Hereinafter, a surge protective device according to a first embodiment of the present invention will be described with reference to FIGS. 1 and 2. In the drawings referenced in the following description, the scale of each component may be changed as appropriate so that each component is recognizable or is readily recognized.

As shown in FIGS. 1 and 2, a surge protective device 1 according to the present embodiment includes an insulating tube 2 and a pair of sealing electrodes 3 for closing the openings on both ends of the insulating tube 2 so as to seal a discharge control gas inside the tube.

The surge protective device 1 according to the present embodiment also includes a discharge-assisting part 4 made of an ion-source material on the inner circumferential surface of the insulating tube 2.

The pair of sealing electrodes 3 has a pair of convex electrode portions 5 projecting inwardly so as to face to each other.

On the inner circumferential surface of the insulating tube 2 is formed at least one groove part 2a extending in a circumferential direction. In the present embodiment, a plurality of groove parts 2a are provided at intervals from each other in the direction of an axis C of the insulating tube 2.

Each of the groove parts 2a is formed by making a slit in the inner circumferential surface of the insulating tube 2 in a vertical direction relative thereto so as to have a rectangular shape. Note that the larger a depth L of the groove part 2a is, the more the formation of an energization circuit due to the adhesion of a metal component to the inside of the groove part 2a can be suppressed.

In addition, each of the groove parts 2a is annularly formed in a circumferential direction around the axis C. These groove parts 2a are fabricated by forming a plurality of grooves having a slit-like shape in the inner circumferential surface of the insulating tube 2 when the insulating tube 2 is fabricated, for example when the insulating tube 2 is molded but before it is sintered, and then by sintering them.

On the opposing surfaces 5b of the convex electrode portions 5 are formed discharge active layers 8 with a material having higher electron emission characteristics than that of the sealing electrodes 3.

The discharge active layers 8 include, for example, Si and O as the main component elements together with at least one of Na, Cs, and C. These discharge active layers 8 are fabricated by adding a cesium carbonate powder to a sodium silicate solution to form a precursor, applying the precursor on the opposing surfaces 5b of the pair of convex electrode portions 5, and then subjecting the applied precursor to a heat treatment at a temperature or higher at which sodium silicate softens and at a temperature or higher cesium carbonate melts and decomposes.

The discharge-assisting part 4 is made of a conductive material such as, for example, a carbon material.

In addition, in the present embodiment, the discharge-assisting part 4 is formed into a straight or dashed line shape along the axis C across the plurality of groove parts 2a.

Note that, although one piece of the discharge-assisting part 4 is shown along the axis C in FIG. 1, a plurality of the discharge-assisting parts 4 may be formed at intervals from each other in a circumferential direction.

The sealing electrodes 3 are composed of, for example, 42-alloy (Fe: 58 wt %, Ni: 42 wt %), Cu, or the like.

Each of the sealing electrodes 3 has a discoidal flange 7 fixed to each of the openings on both ends of the insulating tube 2 with a conductive fusion material (not shown) in a close contact state by a heat treatment. Inside the flange 7, the convex electrode portion 5 having a columnar shape is integrally formed with the flange 7, which projects inwardly and has a smaller outer diameter than the inner diameter of the insulating tube 2.

The insulating tube 2 is made of a crystalline ceramic material such as alumina. However, the insulating tube 2 may be a tube made of a glass such as a lead glass.

The conductive fusion material described above is a brazing material containing Ag, e.g., an Ag—Cu brazing material.

The discharge control gas sealed inside the insulating tube 2 as described above is an inert gas or the like such as, for example, He, Ar, Ne, Xe, Kr, SF₆, CO₂, C₃F₈, C₂F₆, CF₄, H₂, air, etc., or a combination of these gases.

When an overvoltage or overcurrent enters the surge protective device 1, firstly the initial discharge occurs between the discharge-assisting part 4 and the convex electrode portions 5, which triggers further progress of discharge, and then an arc discharge occurs from one of the convex electrode portions 5 to the other of the convex electrode portions 5.

As described above, in the surge protective device 1 according to the present embodiment, since at least one groove part 2a extending in a circumferential direction is formed on the inner circumferential surface of the insulating tube 2, even when a metal component scattered by an arc discharge adheres to the inner circumferential surface of the insulating tube 2, it is hard to enter the groove part 2a. Hence, an energization circuit is hard to be formed due to the adhered metal, and thus the occurrence of a short circuit can be suppressed.

In addition, the groove part 2a can lengthen the creepage distance between the sealing electrodes 3 through the inner circumferential surface of the insulating tube 2, and this can also preclude the formation of an energization circuit due to the adhered metal.

In particular, when the plurality of groove parts 2a are formed in the axial direction of the insulating tube 2, the formation of an energization circuit due to the adhered metal can be further suppressed by the plurality of groove parts 2a, which can further prevent the occurrence of a short circuit.

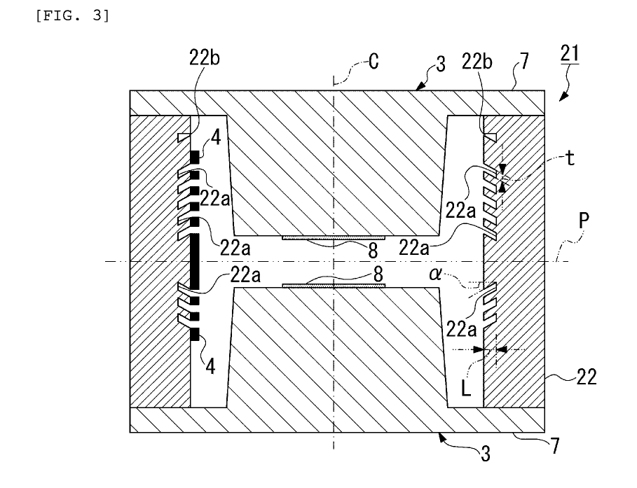

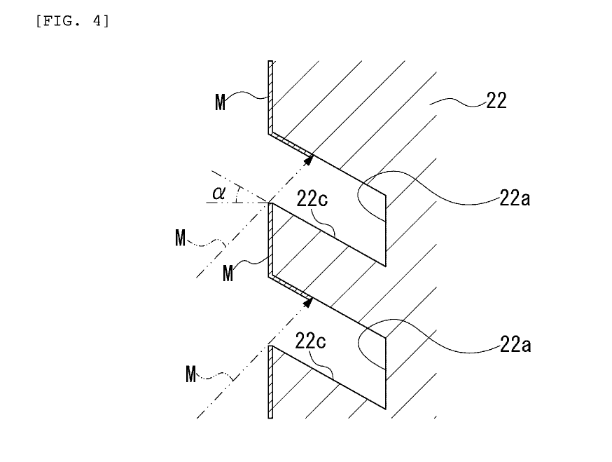

Next, a surge protective device according to a second embodiment of the present invention will be described below with reference to FIGS. 3 and 4. Note that, in the following description of the second embodiment, the same components as those in the first embodiment described above are denoted by the same reference numerals, and thus the description thereof is omitted.

The second embodiment is different from the first embodiment in the following points. In the first embodiment, the groove part 2a is formed by making a slit in the inner circumferential surface of the insulating tube 2 in a vertical direction relative thereto so as to have a rectangular shape, whereas in a surge protective device 21 according to the second embodiment, as shown in FIGS. 3 and 4, the inner surface 22c of the groove parts 22a and 22b on the intermediate position P side in the insulating tube 22 is inclined from the inner circumferential surface of the insulating tube 22 towards the intermediate position P side.

Specifically, in the second embodiment, the groove part 22a is formed by making slit in an oblique direction relative to the direction perpendicular to the inner circumferential surface of the insulating tube 22 so as to have a cross-section having a parallelogram shape where the inclination direction from the inner circumferential surface is facing to the intermediate position P side.

In addition, the groove part 22b is formed in the vicinity of one of the openings of insulating tube 22. The groove part 22b, the inner surface 22c of which on the intermediate position P side in the insulating tube 22 is inclined from the inner circumferential surface of the insulating tube 22 towards the intermediate position P side, has a cross-section having a trapezoidal or generally triangular shape.

Note that the larger the absolute value of inclination angle α of the inner surface 22c is, the harder a metal component M is to adhere to the inner surface 22c. In addition, the larger a depth L and a width t of the groove parts 22a and 22b are, the more the formation of an energization circuit due to the adhesion of the metal component M to the inside of the groove parts 22a and 22b can be suppressed.

As described above, in the surge protective device 21 according to the second embodiment, the inner surface 22c of the groove parts 22a and 22b on the intermediate position P side in the insulating tube 22 is inclined from the inner circumferential surface of the insulating tube 22 towards the intermediate position P side, even when the metal component M scattered from the tip side of the pair of convex electrode portions 5 by an arc discharge tries to adhere to the inside of the groove parts 22a and 22b, it is hard to adhere to the inner surface 22c because it is shaded by the surface of the groove parts 22a and 22b on the intermediate position P side in the direction that the metal component M scatters (e.g., the direction shown by the arrow in FIG. 4). Therefore, an energization circuit can be further hard to be formed due to the adhered metal component M.

In addition, since the groove part 22b is formed in the vicinity of at least one of the openings of insulating tube 22, the groove part 22b can be located in the vicinity of one of the openings to which the metal component M due to arc discharge is harder to adhere than to the central region. Therefore, the occurrence of a short circuit between the pair of sealing electrodes 3 can be effectively prevented.

The technical scope of the present invention is not limited to the aforementioned embodiments, but the present invention may be modified in various ways without departing from the scope or teaching of the present invention.

For example, in each embodiment described above, although the groove part(s) is(are) annularly formed along the inner circumferential surface of the insulating tube, it(they) may be formed in an arc shape along the inner circumferential surface of the insulating tube.

### REFERENCE NUMERALS

1, 21: surge protective device, 2, 22: insulating tube, 3: sealing electrode, 4: discharge-assisting part, 5: convex electrode portion, 2a, 22a, 22b: groove part, 22c: inner surface of the groove part on the intermediate position side in the insulating tube, P: intermediate position in the insulating tube

What is claimed is:

1. A surge protective device comprising:
an insulating tube; and
a pair of sealing electrodes for closing openings on both ends of the insulating tube so as to seal a discharge control gas inside the tube, wherein
the pair of sealing electrodes has a pair of convex electrode portions projecting inwardly so as to face to each other, and
at least one groove part extending in a circumferential direction is formed on the inner circumferential surface of the insulating tube.

2. The surge protective device according to claim 1, wherein a plurality of the groove parts are formed in the axial direction of the insulating tube.

3. The surge protective device according to claim 1, wherein the groove part is formed at least in the vicinity of one of the openings of the insulating tube.

4. The surge protective device according to claim 1, wherein the inner surface of the groove part on the intermediate position side in the insulating tube is inclined from the inner circumferential surface of the insulating tube towards the intermediate position side.
